(19) United States
(12) Patent Application Publication
(10) Pub. No.: US 2024/0348734 A1
(43) Pub. Date: Oct. 17, 2024

(54) IMAGE PROCESSING APPARATUS, CONTROL METHOD, AND NON-TRANSITORY COMPUTER-EXECUTABLE MEDIUM

(71) Applicant: PFU LIMITED, Kahoku-shi (JP)

(72) Inventors: Hirokazu Kawatani, Kahoku-shi (JP); Yuta Hashimoto, Kahoku-shi (JP); Yasuhito Nagakoshi, Kahoku-shi (JP)

(21) Appl. No.: 18/632,008

(22) Filed: Apr. 10, 2024

(30) Foreign Application Priority Data
Apr. 17, 2023 (JP) 2023-067285

(51) Int. Cl. H04N 1/00

(52) U.S. Cl. CPC H04N 1/00824; H04N 1/0048; H04N 1/00801; H04N 2201/0081

(57) ABSTRACT

An image processing apparatus includes circuitry. The circuitry acquires capability information relating to conveyance processing, image-capturing processing, or image processing of an image reading apparatus, and a storage destination of a file that is generated by the image reading apparatus. The circuitry identifies characteristic information of an existing file present in the storage destination. The circuitry determines whether the capability information of the image reading apparatus corresponds to the characteristic information and generates a determination result. The circuitry notifies a user of information relating to the determination result based on the determination result indicating that the capability information does not correspond to the characteristic information.

### CROSS-REFERENCE TO RELATED APPLICATION

This patent application is based on and claims priority pursuant to 35 U.S.C. § 119(a) to Japanese Patent Application No. 2023-067285, filed on Apr. 17, 2023, in the Japan Patent Office, the entire disclosure of which is hereby incorporated by reference herein.

### BACKGROUND

### Technical Field

Embodiments of the present disclosure relate to an image processing apparatus, a control method, and a non-transitory computer-executable medium.

### Related Art

In recent years, image reading apparatuses such as scanners of various types are used for various purposes of use to appropriately capture images of media of various types. However, in order for a user to select an appropriate image reading apparatus in accordance with the purpose of use or the type of medium, the user is required to have knowledge or skill for an image reading process.

An information processing apparatus has been known that displays a screen of a setting field for setting a scan condition, automatically selects an image forming apparatus, and causes the automatically selected image forming apparatus to execute a scan process under the scan condition set in the setting field.

### SUMMARY

According to an embodiment of the present disclosure, an image processing apparatus includes circuitry. The circuitry acquires capability information relating to conveyance processing, image-capturing processing, or image processing of an image reading apparatus, and a storage destination of a file that is generated by the image reading apparatus. The circuitry identifies characteristic information of an existing file present in the storage destination. The circuitry determines whether the capability information of the image reading apparatus corresponds to the characteristic information and generates a determination result. The circuitry notifies a user of information relating to the determination result in a case where the determination result indicates that the capability information does not correspond to the characteristic information.

According to an embodiment of the present disclosure, a control method includes acquiring capability information relating to conveyance processing, image-capturing processing, or image processing of an image reading apparatus, and a storage destination of a file that is generated by the image reading apparatus. The control method includes identifying characteristic information of an existing file present in the storage destination. The control method includes determining whether the capability information of the image reading apparatus corresponds to the characteristic information and generating a determination result. The control method includes notifying a user of information relating to the determination result in a case where the determination result indicates that the capability information does not correspond to the characteristic information.

A non-transitory computer-executable medium stores a control program storing a plurality of instructions, which, when executed by one or more processors, causes the one or more processors to perform a method. The method includes acquiring capability information relating to conveyance processing, image-capturing processing, or image processing of an image reading apparatus, and a storage destination of a file that is generated by the image reading apparatus. The method includes identifying characteristic information of an existing file present in the storage destination. The method includes determining whether the capability information of the image reading apparatus corresponds to the characteristic information and generating a determination result. The method includes notifying a user of information relating to the determination result in a case where the determination result indicates that the capability information does not correspond to the characteristic information.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram schematically illustrating a configuration of an image processing system, according to an embodiment of the present disclosure;

FIG. 2A is a diagram schematically illustrating configurations of a first storage device and a first processing circuit, according to an embodiment of the present disclosure;

FIG. 2B is a diagram schematically illustrating configurations of a second storage device and a second processing circuit, according to an embodiment of the present disclosure;

FIG. 3 is a flowchart of an example of an operation of a determination process, according to an embodiment of the present disclosure;

FIG. 4 is a schematic diagram for describing capability information, according to an embodiment of the present disclosure;

FIG. 5 is a schematic diagram for describing characteristic information, according to an embodiment of the present disclosure;

FIG. 6 is a schematic diagram for describing setting information, according to an embodiment of the present disclosure; and

FIG. 7 is a block diagram schematically illustrating a configuration of another second processing circuit, according to another embodiment of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a”, “an”, and “the” are intended to include the plural forms as well, unless the context clearly indicates otherwise.

An image processing apparatus, a control method, and a control program according to embodiments of the present disclosure are described below with reference to the drawings. However, it is to be understood that the technical scope of the present disclosure is not limited to the embodiments of the disclosure, and pertains to the disclosure described in the claims and the equivalents of the disclosure.

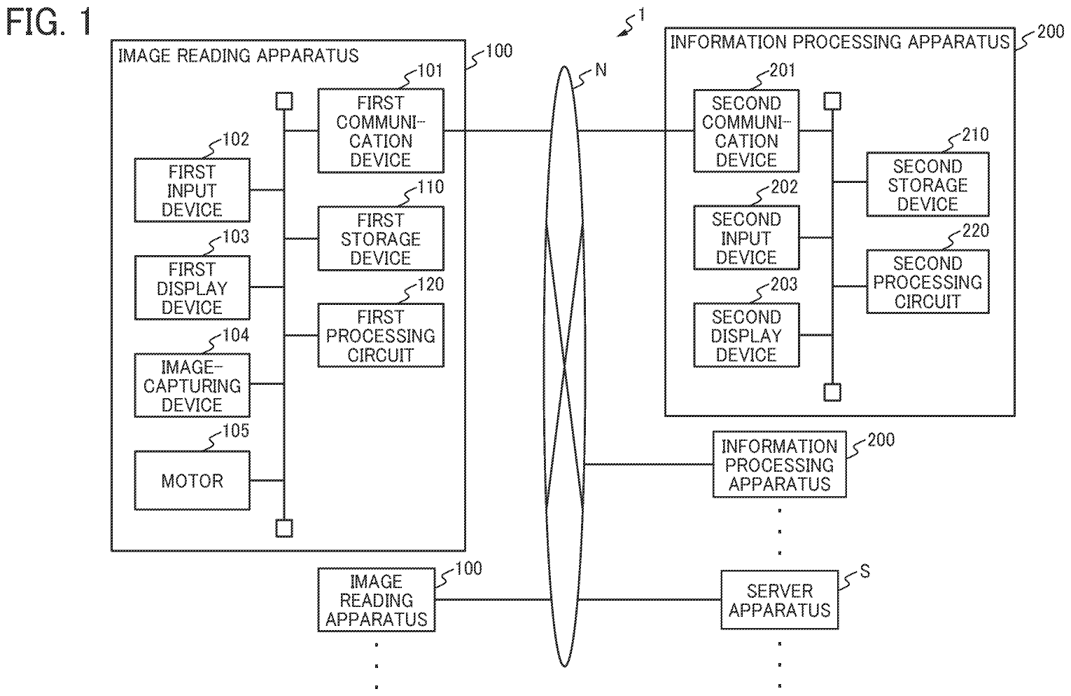

FIG. 1 is a diagram schematically illustrating a configuration of an image processing system 1 according to an embodiment.

As illustrated in FIG. 1, the image processing system 1 includes one or more image reading apparatuses 100, one or more information processing apparatuses 200, and one or more server apparatuses S. The image reading apparatus 100 and the information processing apparatus 200 are examples of an image processing apparatus. The image reading apparatus 100, the information processing apparatus 200, and the server apparatus S are communicably connected to one another via a network N. The network N is, for example, the Internet or an intranet.

The image reading apparatus 100 is, for example, a scanner apparatus. The scanner apparatus includes an auto document feeder (ADF) scanner apparatus that captures an image of a medium that is a document while conveying the medium, or a flatbed scanner apparatus that captures an image of a medium in a fixed manner. Examples of the medium include a sheet of plain paper, a sheet of thin paper, a sheet of thick paper, and a card. Examples of the medium further include various types of media such as a receipt, a business card, a bill, and an invoice. The image reading apparatus 100 may be, for example, a facsimile, a copier, or a multifunction peripheral (MFP). The image reading apparatus 100 may be, for example, a mobile phone, a smartphone, a tablet computer, or a laptop personal computer that captures an image of, for example, a person, an object, or a landscape.

The information processing apparatus 200 is, for example, a personal computer, a laptop personal computer, a tablet computer, or a smartphone. The information processing apparatus 200 may be a server provided in a cloud network. The server apparatus S is, for example, a server provided in a cloud network.

The image reading apparatus 100 includes a first communication device 101, a first input device 102, a first display device 103, an image-capturing device 104, a motor 105, a first storage device 110, and a first processing circuit 120.

The first communication device 101 includes an antenna that transmits and receives wireless signals, and a wireless communication interface circuit to transmit and receive signals through a wireless communication line according to a predetermined communication protocol such as a wireless local area network (LAN). The first communication device 101 transmits and receives image data and various types of information to and from the information processing apparatus 200 in response to an instruction from the first processing circuit 120. The first communication device 101 may include a wired communication interface circuit to transmit and receive signals through a wired communication line according to a predetermined communication protocol such as a wired LAN.

The first input device 102 includes an input device such as a button and an interface circuit that acquires a signal from the input device. The first input device 102 receives an operation by a user, and outputs a signal corresponding to the operation by the user to the first processing circuit 120.

The first display device 103 includes a display including, for example, liquid crystal or organic electro-luminescence (EL), and an interface circuit that outputs image data to the display. The first display device 103 displays various types of information on the display in response to an instruction from the first processing circuit 120.

The image-capturing device 104 captures an image of a medium to generate an input image. The image-capturing device 104 includes an imaging sensor employing a reduction optical system including an imaging element including a one-dimensional or two-dimensional charge coupled device (CCD). The image-capturing device 104 further includes a light source that emits light, a lens that forms an image on the imaging element, and an analog-to-digital (A/D) converter that amplifies an electric signal output from the imaging element and converts the amplified electric signal into a digital signal. In the image-capturing device 104, the imaging sensor captures an image of the front side and/or the back side of a medium to generate and output an analog image signal, and the A/D converter converts the analog image signal to generate a digital input image and outputs the digital input image to the first processing circuit 120. Instead of the CCD, an imaging sensor employing a reduction optical system including an imaging element including a complementary metal oxide semiconductor (CMOS) may be used. A line sensor employing a unity magnification optical system including imaging elements including CMOSs or CCDs may be used.

The motor 105 rotates a roller to convey a medium in accordance with a control signal from the first processing circuit 120. Alternatively, the motor 105 moves the image-capturing device 104 in a sub-scanning direction in accordance with a control signal from the first processing circuit 120.

The first storage device 110 includes memories such as a random access memory (RAM) and a read only memory (ROM), a fixed disk device such as a hard disk, or a portable memory such as a flexible disk or an optical disk. The first storage device 110 stores computer programs, databases, tables, and so forth, which are used for various processes of the image reading apparatus 100. The computer programs may be installed in the first storage device 110 from a computer-readable portable recording medium using, for example, a known setup program. The portable recording medium is, for example, a compact disk read only memory (CD-ROM) or a digital versatile disk read only memory (DVD-ROM). The computer programs may be distributed from, for example, a server and installed in the first storage device 110.

The first processing circuit 120 operates according to a program stored in the first storage device 110 in advance. The first processing circuit 120 is, for example, a central processing unit (CPU). As the first processing circuit 120, for example, a digital signal processor (DSP), a large scale integration (LSI), an application specific integrated circuit (ASIC), or a field-programming gate array (FPGA) may be used.

The first processing circuit 120 is connected to the first communication device 101, the first input device 102, the first display device 103, the image-capturing device 104, the motor 105, the first storage device 110, and so forth, and controls these components. The first processing circuit 120 performs control of transmitting and receiving data to and from the information processing apparatus 200 via the first communication device 101, input control of the first input device 102, display control of the first display device 103, imaging control of the image-capturing device 104, drive control of the motor 105, and so forth.

The information processing apparatus 200 includes a second communication device 201, a second input device 202, a second display device 203, a second storage device 210, and a second processing circuit 220.

The second communication device 201 includes an antenna that transmits and receives wireless signals, and a wireless communication interface circuit to transmit and receive signals through a wireless communication line according to a predetermined communication protocol such as a wireless LAN. The second communication device 201 transmits and receives image data and various types of information to and from the image reading apparatus 100 in response to an instruction from the second processing circuit 220. The second communication device 201 may include a wired communication interface circuit to transmit and receive signals through a wired communication line according to a predetermined communication protocol such as a wired LAN.

The second input device 202 includes an input device, such as a keyboard or a mouse, and an interface circuit that acquires a signal from the input device. The second input device 202 outputs a signal corresponding to an operation by the user to the second processing circuit 220.

The second display device 203 includes a display including, for example, liquid crystal or organic EL, and an interface circuit that outputs image data to the display. The second display device 203 displays various types of information on the display in response to an instruction from the second processing circuit 220.

The second storage device 210 includes memories such as a RAM and a ROM, a fixed disk device such as a hard disk, or a portable memory such as a flexible disk or an optical disk. The second storage device 210 stores computer programs, databases, tables, and so forth, which are used for various processes of the information processing apparatus 200. The computer programs may be installed in the second storage device 210 from a computer-readable portable recording medium, such as a CD-ROM or a DVD-ROM, using, for example, a known setup program. The computer programs may be distributed from, for example, a server and installed in the second storage device 210.

The second processing circuit 220 operates according to a program stored in the second storage device 210 in advance. The second processing circuit 220 is, for example, a CPU. As the second processing circuit 220, for example, a DSP, a LSI, an ASIC, or a FPGA may be used.

The second processing circuit 220 is connected to the second communication device 201, the second input device 202, the second display device 203, the second storage device 210, and so forth, and controls these components. The second processing circuit 220 performs control of transmitting and receiving data to and from the image reading apparatus 100 via the second communication device 201, input control of the second input device 202, display control of the second display device 203, and so forth. The second processing circuit 220 analyzes capability information of the image reading apparatus 100 and an existing file present in a storage destination of a file that is generated by the image reading apparatus 100, and determines whether the capability information corresponds to characteristic information of the existing file. The second processing circuit 220 notifies the user of a warning when the capability information does not correspond to the characteristic information.

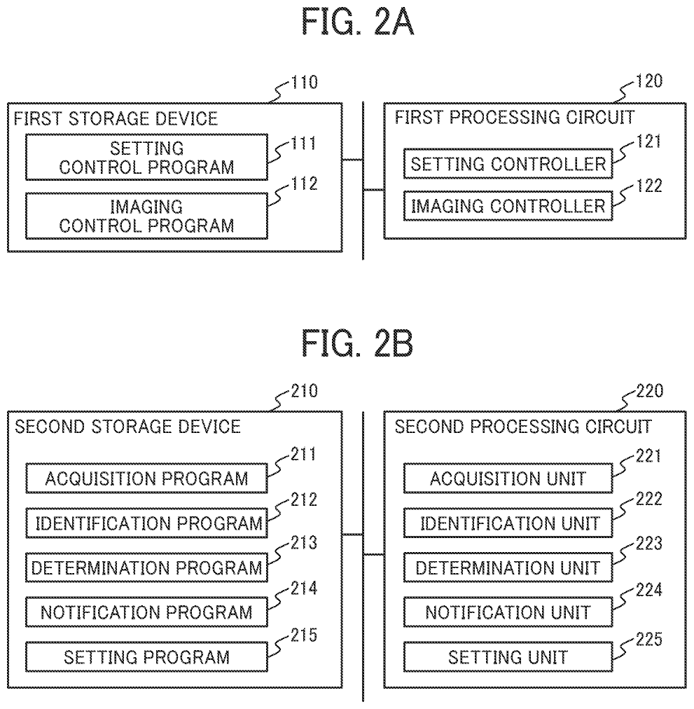

FIG. 2A is a diagram schematically illustrating configurations of the first storage device 110 and the first processing circuit 120.

As illustrated in FIG. 2A, the first storage device 110 stores programs, such as a setting control program 111 and an imaging control program 112. These programs are functional modules implemented by software operating on the processor. The first processing circuit 120 reads the programs from the first storage device 110 and operates according to the read programs. Accordingly, the first processing circuit 120 functions as a setting controller 121 and an imaging controller 122.

FIG. 2B is a diagram schematically illustrating configurations of the second storage device 210 and the second processing circuit 220.

As illustrated in FIG. 2B, the second storage device 210 stores programs, such as an acquisition program 211, an identification program 212, a determination program 213, a notification program 214, and a setting program 215. These programs are functional modules implemented by software operating on the processor. The second processing circuit 220 reads the programs from the second storage device 210 and operates according to the read programs. Accordingly, the second processing circuit 220 functions as an acquisition unit 221, an identification unit 222, a determination unit 223, a notification unit 224, and a setting unit 225.

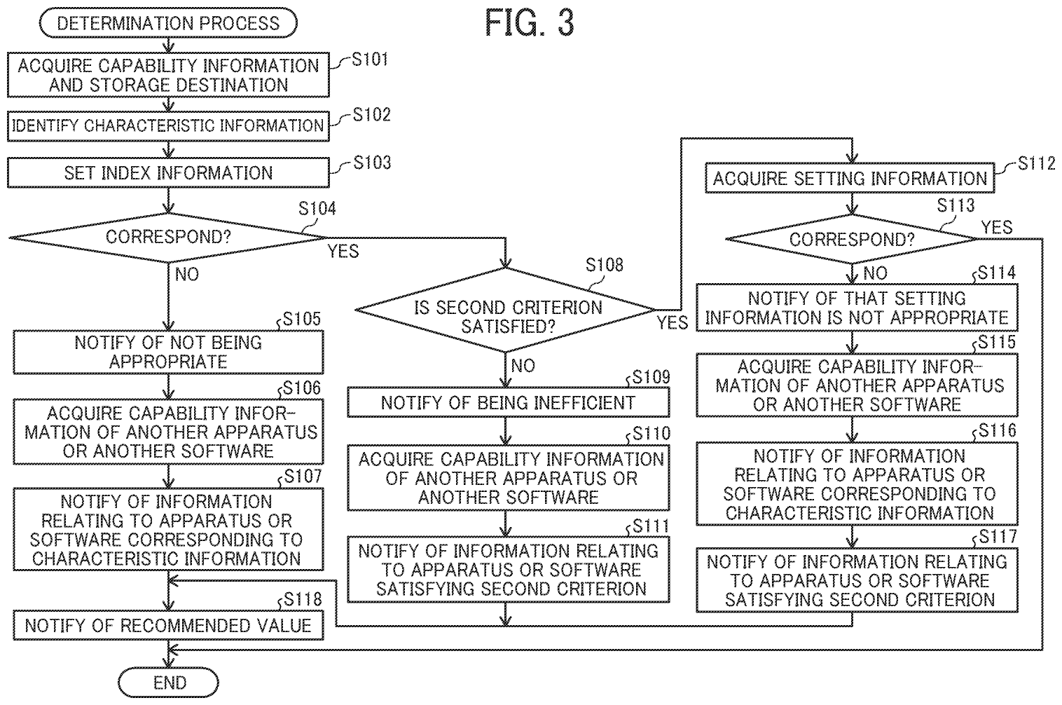

FIG. 3 is a flowchart presenting an example of an operation of a determination process by the information processing apparatus 200. The operation of the determination process is described below with reference to the flowchart presented in FIG. 3. The flow of the operation described below is executed mainly by the second processing circuit 220 in cooperation with each component of the information processing apparatus 200 based on a program stored in the second storage device 210 in advance. The determination process is executed at any timing when instructed by the user or periodically.

The acquisition unit 221 acquires capability information of an image reading apparatus 100 to be used and a storage destination of a file that is generated by the image reading apparatus 100 (step S101).

The acquisition unit 221 acquires information indicating the image reading apparatus 100 to be used and a storage destination designated by the user using the second input device 202 of the information processing apparatus 200. The acquisition unit 221 may receive the information indicating the image reading apparatus 100 to be used and the storage destination designated by the user from the image reading apparatus 100 to be used or another information processing apparatus 200 via the second communication device 201 and acquire the information indicating the image reading apparatus 100 to be used and the storage destination designated by the user.

The acquisition unit 221 transmits a capability information request signal for requesting capability information to the image reading apparatus 100 to be used via the second communication device 201. The image reading apparatus 100 stores capability information of the image reading apparatus 100 in the first storage device 110 in advance. When the setting controller 121 of the image reading apparatus 100 receives the capability information request signal from the information processing apparatus 200 via the first communication device 101, the setting controller 121 transmits the capability information of the image reading apparatus 100 stored in the first storage device 110 to the information processing apparatus 200 via the first communication device 101. The acquisition unit 221 receives the capability information of the image reading apparatus 100 to be used from the image reading apparatus 100 via the second communication device 201 and acquires the capability information. The information processing apparatus 200 may store capability information of each image reading apparatus 100 in the second storage device 210 in advance. The acquisition unit 221 may read the capability information of the image reading apparatus 100 to be used from the second storage device 210 and acquire the capability information.

The file is an image file such as a Joint Photographic Experts Group (JPEG) file or a portable document format (PDF) file including an image generated by the image reading apparatus 100. The storage destination is, for example, a specific address such as a folder or a uniform resource locator (URL) in the second storage device 210 of the information processing apparatus 200. The storage destination may be an address in a storage device of an information processing apparatus 200 different from the information processing apparatus 200 that has acquired the storage destination, the image reading apparatus 100, or the server apparatus S.

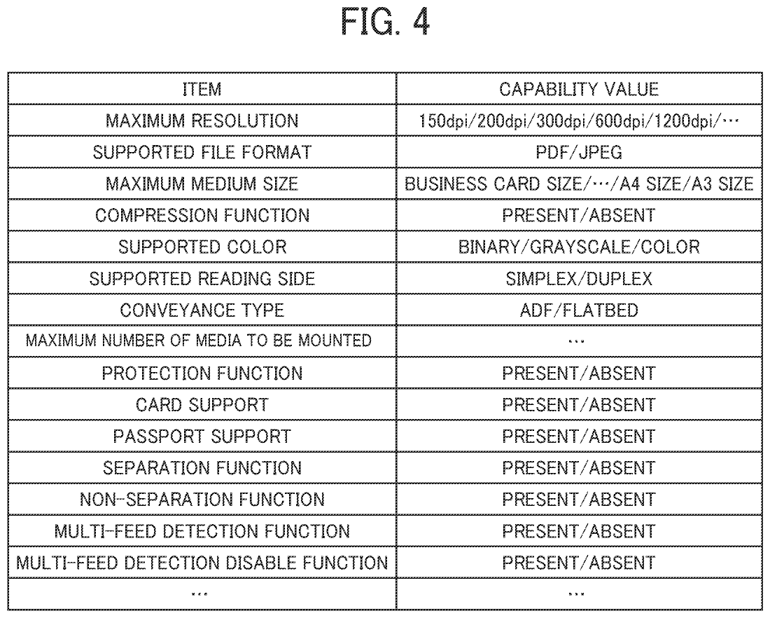

FIG. 4 is a table presenting capability information.

As illustrated in FIG. 4, the capability information is information indicating capabilities relating to conveyance processing, image-capturing processing, or image processing of the image reading apparatus 100. The capability information includes a list of capability values indicating functions supported by the image reading apparatus 100 for a plurality of items. The items provided in the capability information include maximum resolution, supported file format, maximum medium size, compression function, supported color, supported reading side, conveyance type, maximum number of media to be mounted, protection function, card support, passport support, separation function, non-separation function, multi-feed detection function, multi-feed detection disable function, and so forth. The maximum resolution, maximum medium size, supported color, supported reading side, and so forth are capabilities relating to the image-capturing processing. The supported file format, compression function, and so forth are capabilities relating to the image processing. The conveyance type, maximum number of media to be mounted, protection function, card support, passport support, separation/non-separation function, multi-feed detection function, and so forth are capabilities relating to the conveyance processing.

The maximum resolution is the resolution of an image that can be generated by the image reading apparatus 100. As a capability value of the maximum resolution, for example, 150 dots per inch (dpi), 200 dpi, 300 dpi, 600 dpi, or 1200 dpi is set. The supported file format is the format of a file of an image that can be generated by the image reading apparatus 100. As a capability value of the supported file format, for example, PDF or JPEG is set. The maximum medium size is the size of a medium from which an image can be captured by the image reading apparatus 100. As a capability value of the maximum medium size, for example, business card size, A4 size, or A3 size is set. The compression function is a function of executing image compression such as JPEG on an image to be generated. As a capability value of the compression function, for example, present or absent is set. The supported color is a setting of the color of an image that can be generated by the image reading apparatus 100. As a capability value of the supported color, for example, binary, grayscale, or color is set. The supported reading side is a side of a medium from which an image can be captured by the image reading apparatus 100. As a capability value of the supported reading side, for example, simplex or duplex is set.

The conveyance type indicates whether the image reading apparatus 100 is a type that a medium is conveyed to an image-capturing surface or a type that a medium is placed on the image-capturing surface. As a capability value of the conveyance type, for example, ADF or flatbed is set. The maximum number of media to be mounted indicates the maximum number of media collectively mounted on a mount table of the image reading apparatus 100, that is, the number of media collectively sequentially conveyable by the image reading apparatus 100. As a capability value of the maximum number of media to be mounted, the maximum number of media collectively mounted on the mount table is set. In a case where the conveyance type is flatbed, 1 is set as the capability value of the maximum number of media to be mounted. The protection function is a function of preventing damage to a medium to be conveyed. As a capability value of the protection function, for example, present or absent is set. In the case where the conveyance type is flatbed, damage to a medium is less likely to occur, and present is set as the capability value of the protection function. In a case where the conveyance type is ADF, present is set when conveyance of colorless and transparent carrier sheets with a medium interposed therebetween is supported, and absent is set when conveyance of the carrier sheets is not supported.

The card support is a function of supporting image capturing of a card such as a credit card or a cash card. As a capability value of the card support, for example, present or absent is set. The passport support is a function of supporting image capturing of a passport. As a capability value of the passport support, for example, present or absent is set. The separation function is a function of conveying media while separating the media one by one. As a capability value of the separation function, for example, present or absent is set. The non-separation function is a function of conveying media without separating the media. As a capability value of the non-separation function, for example, present or absent is set. The multi-feed detection function is a function of making a notification of a warning or stopping conveyance when multi-feed of media occurs. As a capability value of the multi-feed detection function, for example, present or absent is set. The multi-feed detection disable function is a function of disabling (turning OFF) the multi-feed detection of media. As a capability value of the multi-feed detection disable function, for example, present or absent is set.

The identification unit 222 identifies characteristic information of an existing file based on the existing file present in the designated storage destination (step S102). When the storage destination is a storage device of an apparatus different from the information processing apparatus 200, the identification unit 222 receives the designated storage destination and information relating to an existing file present in the storage destination from the apparatus of the storage destination via the second communication device 201. When the designated storage destination is not accessible for any reason, or when an existing file is not present in the designated storage destination, the identification unit 222 notifies the user of a warning indicating that an existing file is not present in the designated storage destination, and ends the series of steps.

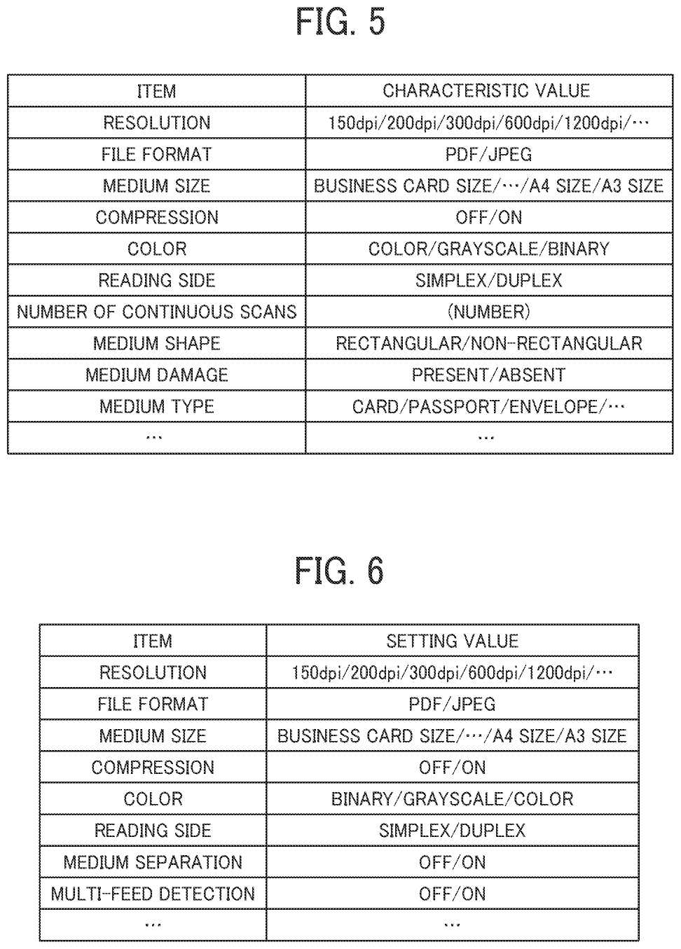

FIG. 5 is a table presenting characteristic information.

As illustrated in FIG. 5, the characteristic information is information indicating characteristics of an existing file. The characteristic information includes information relating to the conveyance processing, the image-capturing processing, or the image processing of the image reading apparatus 100 when an existing file is generated. The characteristic information indicates characteristic values for a plurality of items. The items provided in the characteristic information include resolution, file format, medium size, compression, color, reading side, number of continuous scans, medium shape, medium damage, medium type, and so forth. The resolution, medium size, color, reading side, and so forth are characteristics relating to the image-capturing processing. The file format, compression, and so forth are characteristics relating to the image processing. The number of continuous scans, medium shape, medium damage, medium type, and so forth are characteristics relating to the conveyance processing.

The identification unit 222 refers to meta information included in an existing file and identifies characteristic values of the resolution, medium size, file format, compression, and color of an image included in the existing file. The identification unit 222 may identify the resolution or medium size from the medium size or resolution included in the meta information and the number of pixels of the image included in the existing file. The identification unit 222 may estimate the resolution based on the spatial frequency of the image included in the existing file. In this case, an expression or a table indicating the relationship between the maximum value of the spatial frequency and the resolution is set in the second storage device 210 in advance. The identification unit 222 identifies the resolution corresponding to the spatial frequency with reference to the expression or the table set in advance. The identification unit 222 may compare the maximum difference in gradation value among pixels in each pixel block of the image included in the existing file with a threshold value to estimate whether the compression is present or absent. The identification unit 222 may identify the setting value of the color (binary, grayscale, color) based on the distribution (range) of color values and/or brightness values of the image included in the existing file.

The identification unit 222 determines whether the characteristic value of the reading side is simplex or duplex based on whether serial numbers such as page numbers are included in two images included in two existing files having names or creation dates and times being adjacent to each other, or based on whether the similarity degree of images is a threshold value or more. The similarity degree is, for example, a normalized cross-correlation value.

When the file format of an existing file is PDF and a plurality of images are included in one existing file, the identification unit 222 determines that a plurality of media have been collectively conveyed, and identifies the number of images included in the existing file as the characteristic value of the number of continuous scans. The identification unit 222 determines that a plurality of existing files having a difference in creation date and time within a predetermined period of time (for example, 3 seconds) include images captured while a plurality of media is collectively conveyed, and identifies the total number of images included in the existing files as the characteristic value of the number of continuous scans.

The identification unit 222 detects a medium area in an image included in an existing file using a known image processing technique. The identification unit 222 identifies the characteristic value of the medium shape as rectangular when the shape of the detected medium area is rectangular, and identifies the characteristic value of the medium shape as non-rectangular when the shape of the medium area is not rectangular. The identification unit 222 identifies that the characteristic value of the medium damage is present when the shape of the detected medium area is substantially rectangular and a portion (a side or a corner) thereof is defective, and identifies that the characteristic value of the medium damage is absent when the shape of the medium area is substantially rectangular and there is no defect. The identification unit 222 may identify that the characteristic value of the medium damage is present when detecting a wrinkle in an image included in an existing file. When detecting a predetermined number or more of line segments extending in mutually different directions within a predetermined range of an image using a known image processing technique, the identification unit 222 determines that the area in the range includes a wrinkle.

The identification unit 222 may identify the medium shape and/or the presence of the medium damage using a discriminator trained in advance to output, when an image is input, the shape and/or the presence of the damage of the image. The discriminator is trained in advance by, for example, deep learning using a plurality of images including media having various shapes and/or media with damages in various forms, and is stored in the second storage device 210 in advance. The identification unit 222 inputs an image included in an existing file to the discriminator, and identifies the medium shape and/or the presence of the medium damage corresponding to the existing file based on information output from the discriminator.

When an image included in an existing file includes embossing, the identification unit 222 determines that a card has been conveyed, and identifies the characteristic value of the medium type as card. The identification unit 222 detects a numeral in the image using an optical character recognition (OCR) technique, and calculates the difference in gradation value between pixels adjacent to each other in the area where the numeral is detected. The identification unit 222 determines that the image includes embossing when a predetermined number or more of calculated differences in gradation value are within a range that can be regarded as a shadow due to embossing.

When an image included in an existing file includes a machine readable zone (MRZ), the identification unit 222 determines that a passport has been conveyed, and identifies the characteristic value of the medium type as passport. The identification unit 222 determines whether the image includes a MRZ using an OCR technique.

When an image included in an existing file includes a zip code entry frame or a sticky note, the identification unit 222 determines that an envelope or a sheet with a sticky note attached has been conveyed, and identifies the characteristic value of the medium type as envelope or sheet with sticky note attached. The identification unit 222 detects a rectangular area from the image using a known image processing technique, and determines that the image includes an envelope or a sticky note when the size of the detected rectangular area is regarded as a zip code entry frame or a sticky note. The identification unit 222 determines that the image includes an envelope when detecting characters specific to an envelope, such as “postage deferred payment” or “closed (seal)”, from the image using an OCR technique.

The identification unit 222 may identify the medium type corresponding to an existing file using a discriminator trained in advance to output, when an image is input, information indicating the medium type included in the image. The discriminator is trained in advance by, for example, deep learning using a plurality of images including various types of media, and is stored in the second storage device 210 in advance. The identification unit 222 inputs an image included in an existing file to the discriminator, and identifies the type indicated in information output from the discriminator as the medium type corresponding to the existing file.

The identification unit 222 may store characteristic information identified from an image included in an existing file in meta information of the existing file. Alternatively, the identification unit 222 may generate a list in which characteristic information identified from an image included in an existing file is stored. Accordingly, thereafter, when another information processing apparatus 200 or the image reading apparatus 100 has to identify the characteristic information of the existing file, the other information processing apparatus 200 or the image reading apparatus 100 can identify the characteristic information more easily in a short period of time.

The identification unit 222 sets index information based on the identified characteristic information of each existing file (step S103). The index information is information indicating indices regarding the capabilities in the conveyance processing, the image-capturing processing, or the image processing required for the image reading apparatus 100, and in particular is information indicating indices required for generating an image stored in the designated storage destination. The index information is a list of index values indicating functions desired for the image reading apparatus 100 for a plurality of items. The items determined in the index information are the same as the items determined in the capability information.

The identification unit 222 sets the maximum characteristic value among characteristic values of resolutions of existing files as the index value of the maximum resolution. The identification unit 222 may set flatbed that can capture an image with high resolution as the index value of the conveyance type when the characteristic value of the resolution of any existing file among the existing files is a threshold value (for example, 1200 dpi) or more. The identification unit 222 sets all types of the characteristic values of the file format of the existing files as the index values of the supported file format. The identification unit 222 sets the maximum characteristic value among characteristic values of the medium size of the existing files as the index value of the maximum medium size. The identification unit 222 sets present as the index value of the compression function when the characteristic value of the compression of any existing file among the existing files is present, and sets absent as the index value of the compression function when the characteristic values of the compression of all existing files are absent. The identification unit 222 sets all types of the characteristic values of the color of the existing files as the index values of the supported color. The identification unit 222 sets duplex as the index value of the supported reading side when the characteristic value of the reading side of any existing file among the existing files is duplex, and sets simplex as the index value of the supported reading side when the characteristic values of the reading side of all existing files are simplex. The identification unit 222 may set ADF as the index value of the conveyance type when the characteristic value of the reading side of any existing file among the existing files is duplex.

The identification unit 222 sets ADF as the index value of the conveyance type when the characteristic value of the number of continuous scans of any existing file among the existing files is 2 or more, and sets flatbed as the index value of the conveyance type when the characteristic values of the reading side of all existing files are 1. The identification unit 222 sets present as the index value of the separation function and sets present as the index value of the multi-feed detection function when the characteristic value of the number of continuous scans of any existing file among the existing files is 2 or more. The identification unit 222 sets the maximum characteristic value among characteristic values of the number of continuous scans of the existing files as the index value of the maximum number of media to be mounted. The identification unit 222 sets present as the index value of the protection function to prevent a medium from being damaged when the characteristic value of the medium shape of any existing file among the existing files is non-rectangular. The identification unit 222 sets present as the index value of the protection function when the characteristic value of the medium damage of any existing file among the existing files is present. The identification unit 222 may set flatbed as the index value of the conveyance type so that damage does not increase during medium conveyance when the characteristic value of the medium damage of any existing file among the existing files is present.

The identification unit 222 sets the index value of the card support to present and sets the index value of the multi-feed detection disable function to present when the characteristic value of the medium type of any existing file among the existing files is card. The identification unit 222 sets the index value of the passport support to present and sets the index value of the non-separation function to present when the characteristic value of the medium type of any existing file among the existing files is passport. The identification unit 222 sets the index value of the multi-feed detection disable function to present when the characteristic value of the medium type of any existing file among the existing files is envelope or sheet with sticky note. The identification unit 222 may set the index value of the non-separation function to present when the characteristic value of the medium type of any existing file among the existing files is envelope.

The determination unit 223 determines whether the capability information of the image reading apparatus 100 to be used corresponds to the identified characteristic information (step S104). The determination unit 223 determines whether the capability information of the image reading apparatus 100 to be used satisfies a first criterion for the characteristic information based on whether the capability information of the image reading apparatus 100 to be used satisfies the first criterion for the index information set based on the characteristic information. The determination unit 223 determines whether the capability information of the image reading apparatus 100 to be used corresponds to the characteristic information based on whether the capability information of the image reading apparatus 100 to be used satisfies the first criterion for the characteristic information.

For example, the determination unit 223 determines whether the capability value indicated in the capability information includes the index value indicated in the index information for each item of which the index value is set among the items determined in the index information. The determination unit 223 determines that the capability value includes the index value when the capability value is the index value or more for the maximum resolution or the maximum medium size. The determination unit 223 determines that the capability value includes the index value when the capability value indicates duplex or when both the capability value and the index value indicate simplex for the supported reading side. The determination unit 223 determines that the capability value includes the index value when the capability value is present or when both the capability value and the index value are absent for an item of which the capability value and the index value are determined as present or absent. The determination unit 223 calculates the ratio of the number of items with the capability values including the index values to the number of items with the index values set, as a matching degree at which the capability information matches the index information. The determination unit 223 may calculate the number of items with the capability values including the index values as the matching degree at which the capability information matches the index information. The determination unit 223 determines that the capability information satisfies the first criterion for the index information when the calculated matching degree is a first threshold value determined in advance or more, and determines that the capability information does not satisfy the first criterion for the index information when the calculated matching degree is less than the first threshold value.

The determination unit 223 may determine that the capability information satisfies the first criterion for the index information when the capability values include the index values for all items. The determination unit 223 may determine whether the capability information satisfies the first criterion for the index information based only on one or more items determined in advance among the items determined in the index information. For example, when an image reading apparatus 100 having a small maximum number of media to be mounted is used, work efficiency of the user decreases. However, the image reading apparatus 100 can still acquire a desirable image. Accordingly, for example, the maximum number of media to be mounted may be excluded from the items to be determined. A score may be set in advance for each item, and the determination unit 223 may calculate the sum of scores set for items with the capability values including the index values, or a division value obtained by dividing the sum by the number of items to be determined, as the matching degree.

When it is determined that the capability information does not correspond to the characteristic information, the notification unit 224 notifies the user of a warning indicating that the image reading apparatus 100 to be used is not appropriate (step S105). The warning is an example of information relating to a determination result. The notification unit 224 displays the warning on the second display device 203, or transmits the warning to the image reading apparatus 100 or another information processing apparatus 200 via the second communication device 201 and causes the apparatus to display the warning to notify the user of the warning. The notification unit 224 may notify the user of a list of items with the capability values not including the index values among the items of the capability information of the image reading apparatus 100 to be used, as a list of items with the capabilities being insufficient. The list of items with the capabilities being insufficient is an example of information relating to a determination result. Accordingly, the user can recognize that the image reading apparatus 100 to be used has a possibility of not generating a desirable image, and can reconsider the image reading apparatus 100 to be used. The user does not perform trial and error on the image reading apparatus 100 with the capabilities for generating a desirable image being insufficient. The information processing apparatus 200 can enhance convenience of the user.

The acquisition unit 221 acquires capability information of other image reading apparatuses different from the image reading apparatus 100 to be used or other software different from software installed in the image reading apparatus 100 to be used (step S106). The software is, for example, driver software that causes the image reading apparatus 100 to execute each process. Capability information of each image reading apparatus or each software included in the image processing system 1 is stored in advance, for example, in the second storage device 210 of the information processing apparatus 200 or a storage device of the server apparatus S. The acquisition unit 221 reads the capability information of each image reading apparatus or each software from the second storage device 210 or receives the capability information of each image reading apparatus or each software from the server apparatus S via the second communication device 201 to acquire the capability information of each image reading apparatus or each software. The acquisition unit 221 may receive the capability information of each image reading apparatus or each software from each image reading apparatus with each software installed via the second communication device 201 to acquire the capability information of each image reading apparatus or each software.

The notification unit 224 identifies information relating to an image reading apparatus or software having capabilities corresponding to the identified characteristic information among the other image reading apparatuses or the other software, and notifies the user of the information in a manner similar to the process in step S105 (step S107). The information relating to the image reading apparatus or the software having the capabilities corresponding to the characteristic information is an example of information relating to a determination result, and is, for example, information indicating each image reading apparatus or each software.

The notification unit 224 determines whether the capability information corresponds to the characteristic information for each of the other image reading apparatuses or the other software with the capability information acquired, in a manner similar to the process in step S104. The notification unit 224 notifies the user of information indicating each image reading apparatus or each software with the capability information corresponding to the characteristic information. The notification unit 224 may notify the user of information indicating an image reading apparatus or software having the maximum matching degree among image reading apparatuses or software with capability information corresponding to the characteristic information. Accordingly, the user can recognize the image reading apparatus or the software that can generate a file corresponding to the designated storage destination, and can acquire a desirable file using the image reading apparatus or the software. Thus, the information processing apparatus 200 can enhance the convenience of the user.

By contrast, when it is determined that the capability information of the image reading apparatus 100 to be used corresponds to the characteristic information in step S104, the determination unit 223 determines whether the capability information of the image reading apparatus 100 to be used satisfies a second criterion for the identified characteristic information (step S108). The second criterion is an example of a predetermined criterion. The second criterion is a criterion different from the first criterion and is a criterion stricter than the first criterion. The determination unit 223 determines whether the second criterion is satisfied for the characteristic information based on whether the capability information of the image reading apparatus 100 to be used satisfies the second criterion for the index information set based on the characteristic information.

For example, when the capability value of the maximum number of media to be mounted is less than the index value of the maximum number of media to be mounted, the determination unit 223 determines that the capability information does not satisfy the second criterion for the index information. When the capability value of the maximum number of media to be mounted of the image reading apparatuses 100 is less than the index value of the maximum number of media to be mounted, the image reading apparatus 100 can still acquire a desirable image; however, the work efficiency of the user decreases. When the capability value of the maximum medium size is the index value of the maximum medium size or more and is less than 141% of the index value, and when there is another image reading apparatus with the capability value of the maximum medium size being 141% of the index value or more, the determination unit 223 determines that the capability information does not satisfy the second criterion for the index information. In this case, the image reading apparatus 100 can convey a medium having the size of the index value among media having sizes (size A, size B) according to the rules of International Organization for Standardization (ISO) or Japanese Industrial Standards (JIS). However, the image reading apparatus 100 cannot convey a medium having the size of the index value in a laterally placed manner (in a manner that the longitudinal direction is orthogonal to the conveyance direction). When the medium having the size of the index value can be laterally placed and conveyed, the period of time used for conveyance of each medium is reduced and the work efficiency of the user increases. By contrast, when any or all of the above-described conditions are not satisfied, the determination unit 223 determines that the capability information satisfies the second criterion for the index information.

The determination unit 223 may determine that the capability information satisfies the second criterion for the index information when the matching degree calculated in step S104 is a second threshold value or more, and determine that the capability information does not satisfy the second criterion for the index information when the matching degree is less than the second threshold value. The second threshold value is set in advance to a value larger than the first threshold value. The determination unit 223 may calculate the matching degree using an item excluded in step S104 among the items determined in the index information and determine whether the capability information satisfies the second criterion for the index information based on whether the matching degree is a third threshold value determined in advance or more.

When it is determined that the capability information does not satisfy the second criterion for the characteristic information, the notification unit 224 notifies the user of a warning indicating that the image reading apparatus 100 to be used is inefficient, in a manner similar to the process in step S105 (step S109). The notification unit 224 may notify the user of a list of items that have caused the determination that the second criterion is not satisfied, as a list of items being inefficient, among the items of the capability information of the image reading apparatus 100 to be used. The list of items being inefficient is an example of information relating to a determination result. Accordingly, the user can recognize the possibility of inefficiency when the user uses the image reading apparatus 100 to be used, and can reconsider the image reading apparatus 100 to be used. Thus, the information processing apparatus 200 can enhance the convenience of the user.

The acquisition unit 221 acquires capability information of other image reading apparatuses different from the image reading apparatus 100 to be used or other software different from the software installed in the image reading apparatus 100 to be used, in a manner similar to the process in step S106 (step S110).

The notification unit 224 identifies information relating to an image reading apparatus or software with capability information satisfying the second criterion for the characteristic information, among the other image reading apparatuses or the other software, and notifies the user of the information in a manner similar to the process in step S105 (step S111). The information relating to the image reading apparatus or the software with the capability information satisfying the second criterion for the characteristic information is, for example, information indicating each image reading apparatus or each software.

The notification unit 224 determines whether the capability information satisfies the second criterion for the characteristic information for each of the other image reading apparatuses or the other software with the capability information acquired, in a manner similar to the process in step S108. The notification unit 224 notifies the user of information indicating each image reading apparatus or each software with the capability information satisfying the second criterion for the characteristic information. The notification unit 224 may notify the user of information indicating an image reading apparatus or software having the maximum matching degree among image reading apparatuses or software with capability information satisfying the second criterion for the characteristic information. Accordingly, the user can recognize the image reading apparatus or the software that can efficiently generate a file corresponding to the designated storage destination, and can acquire a desirable file using the image reading apparatus or the software. Thus, the information processing apparatus 200 can enhance the convenience of the user.

By contrast, in step S108, when it is determined that the capability information of the image reading apparatus 100 to be used satisfies the second criterion for the characteristic information, the acquisition unit 221 acquires setting information currently set in the image reading apparatus 100 to be used (step S112).

FIG. 6 is a table presenting setting information.

As illustrated in FIG. 6, the setting information is information indicating settings relating to the conveyance processing, the image-capturing processing, or the image processing in the image reading apparatus 100. The setting information is information for determining, for example, an operation when an image of a medium is captured or the content of image processing to be executed on the captured image by the image reading apparatus 100. Items determined in the setting information include resolution, file format, medium size, compression, color, reading side, medium separation, multi-feed detection, and so forth. The resolution, medium size, color, reading side, and so forth are settings relating to the image- capturing processing. The file format, compression, and so forth are settings relating to the image processing. The medium separation, multi-feed detection, and so forth are settings relating to the conveyance processing.

The resolution is a setting of the resolution of an image to be generated. As a setting value of the resolution, for example, 150 dpi, 200 dpi, 300 dpi, 600 dpi, or 1200 dpi is set. The file format is a setting of the format of a file of an image to be generated. As a setting value of the file format, for example, PDF or JPEG is set. The medium size is a setting of the size of a medium included in an image to be generated. As a setting value of the medium size, for example, business card size, A4 size, or A3 size is set. The compression is a setting for executing image compression such as JPEG on an image to be generated. As a setting value of the compression, for example, ON or OFF is set. The color is a setting of the color of an image to be generated. As a setting value of the color, for example, binary, grayscale, or color is set. The reading side is a setting of a side from which an image of a medium is captured. As a setting value of the reading side, for example, simplex or duplex is set.

The medium separation is a setting of whether to convey media while separating the media one by one or to convey the media without separating the media when the media are conveyed. As a setting value of the medium separation, for example, ON (separation) or OFF (non-separation) is set. When a plurality of media is collectively conveyed, the setting value of the medium separation is set to ON. When a booklet such as a passport is conveyed, the setting value of the medium separation is set to OFF. The multi-feed detection is a setting of whether to notify a user of a warning or stop conveyance when multi-feed of media occurs. As a setting value of the multi-feed detection, for example, ON or OFF is set. When a plurality of sheets is conveyed, the setting value of the multi-feed detection is set to ON. When, for example, an envelope or a sheet with a sticky note attached is conveyed, the setting value of the multi-feed detection is set to OFF.

Before the determination process is executed, the setting controller 121 of the image reading apparatus 100 to be used acquires setting information and a storage destination input by the user using the first input device 102, and stores (sets) the setting information and the storage destination in the first storage device 110. Alternatively, the setting controller 121 receives setting information and a storage destination from the information processing apparatus 200 via the first communication device 101, and stores (sets) the setting information and the storage destination in the first storage device 110. In this case, the setting unit 225 of the information processing apparatus 200 acquires the setting information and the storage destination input by the user using the second input device 202, and transmits and sets the setting information and the storage destination to the image reading apparatus 100 to be used via the second communication device 201. The setting unit 225 may receive setting information set by the user in a second image reading apparatus that is different from the image reading apparatus 100 to be used, from the second image reading apparatus to acquire the setting information in the second image reading apparatus. In this case, the setting controller 121 of the second image reading apparatus reads the setting information already stored (set) in the first storage device 110 from the first storage device 110, and transmits the setting information to the information processing apparatus 200 via the first communication device 101. The setting unit 225 of the information processing apparatus 200 receives the setting information and the storage destination from the second image reading apparatus via the second communication device 201, and transmits and sets the setting information and the storage destination to the image reading apparatus 100 to be used via the second communication device 201.

When the imaging controller 122 receives an instruction signal that designates setting information and instructs image capturing of a medium from the first input device 102 or from the information processing apparatus 200 via the first communication device 101, the imaging controller 122 executes the conveyance processing, the image-capturing processing, and the image processing in accordance with the setting information designated in the instruction signal. The imaging controller 122 controls the image-capturing device 104 and the motor 105 in accordance with the designated setting information to acquire an input image, executes the image processing on the input image in accordance with the designated setting information, and generates a file. The imaging controller 122 transmits a request signal including the generated file and a storage destination stored in association with the setting information of the file and requesting that the file is to be stored in the storage destination, to an apparatus corresponding to the storage destination via the first communication device 101. The apparatus, which has received the request signal, stores the file included in the request signal in the storage destination included in the request signal. When the storage destination is the first storage device 110 of the image reading apparatus 100, the imaging controller 122 stores the generated file into the storage destination in the first storage device 110.

The acquisition unit 221 transmits a setting information request signal for requesting the image reading apparatus 100 to be used to acquire currently set setting information via the second communication device 201. When the setting controller 121 of the image reading apparatus 100 receives the setting information request signal from the information processing apparatus 200 via the first communication device 101, the setting controller 121 reads the currently set setting information from the first storage device 110, and transmits the setting information to the information processing apparatus 200 via the first communication device 101. The acquisition unit 221 receives the setting information currently set in the image reading apparatus 100 to be used from the image reading apparatus 100 via the second communication device 201 to acquire the setting information currently set in the image reading apparatus 100 to be used.

The determination unit 223 determines whether the setting information currently set in the image reading apparatus 100 to be used corresponds to the identified characteristic information (step S113).

The identification unit 222 generates mainstream characteristic information of entire existing files present in the designated storage destination based on statistics of characteristic information of the existing files. The identification unit 222 extracts a characteristic value having the maximum frequency, that is, the mode of characteristic values for each of the plurality of items of the characteristic information of the existing files. The identification unit 222 generates a combination of the modes extracted for the items as the mainstream characteristic information. The identification unit 222 may generate the mainstream characteristic information focusing on one or more items determined in advance instead of all of the items. The identification unit 222 may extract characteristic information of an existing file having the largest number of items of which values of the characteristic information is the same as the modes as the mainstream characteristic information. When there is one existing file stored in a target storage destination, the identification unit 222 identifies characteristic information of the existing file as the mainstream characteristic information.

The determination unit 223 determines whether the setting value in the setting information corresponds to the characteristic value in the mainstream characteristic information for each item of which the characteristic value is identified among the items determined in the setting information. For the item of the medium separation, the determination unit 223 determines that the setting value corresponds to the characteristic value when the setting value of the medium separation is ON and the characteristic value of the number of continuous scans is 2 or more, or when the setting value of the medium separation is OFF and the characteristic value of the medium type is passport, and determines that the characteristic value is not identified in other cases. For the item of the multi-feed detection, the determination unit 223 determines that the setting value corresponds to the characteristic value when the setting value of the multi-feed detection is ON and the characteristic value of the number of continuous scans is 2 or more, or when the setting value of the multi-feed detection is OFF and the characteristic value of the medium type is envelope or sheet with sticky note attached, and determines that the characteristic value is not identified in other cases. For other items, the determination unit 223 determines that the setting value corresponds to the characteristic value when the setting value matches the characteristic value, and determines that the setting value does not correspond to the characteristic value when the setting value does not match the characteristic value.

The determination unit 223 calculates the ratio of the number of items with the setting values corresponding to the characteristic values to the number of items to be determined as a matching degree between the setting information and the characteristic information. The determination unit 223 may calculate the number of items with the setting values corresponding to the characteristic values as the matching degree between the setting information and the characteristic information. The determination unit 223 determines that the setting information corresponds to the characteristic information when the matching degree between the setting information and the characteristic information is a threshold value determined in advance or more, and determines that the setting information does not correspond to the characteristic information when the matching degree between the setting information and the characteristic information is less than the threshold value determined in advance.

When the setting information corresponds to the characteristic information, the notification unit 224 ends the series of steps without notifying the user of a warning. In this case, the notification unit 224 may notify the user of that the image reading apparatus 100 to be used is appropriate, that the image reading apparatus 100 to be used is efficient, and/or that the setting information currently set in the image reading apparatus 100 to be used is appropriate.

By contrast, when the setting information does not correspond to the characteristic information, the notification unit 224 notifies the user of a warning indicating that the setting information currently set in the image reading apparatus 100 to be used is not appropriate, in a manner similar to the process in step S105 (step S114). The notification unit 224 may notify the user of a list of items with the setting values not corresponding to the characteristic values among the items of the setting information currently set in the image reading apparatus 100 to be used as a list of items with the setting information being not appropriate.

The acquisition unit 221 acquires capability information of other image reading apparatuses different from the image reading apparatus 100 to be used or other software different from the software installed in the image reading apparatus 100 to be used, in a manner similar to the process in step S106 (step S115).

The notification unit 224 identifies information relating to an image reading apparatus or software having capabilities corresponding to the identified characteristic information among the other image reading apparatuses or the other software and notifies the user of the information in a manner similar to the process in step S107 (step S116). Accordingly, the user can recognize the image reading apparatus or the software that can generate a file corresponding to the designated storage destination, and can acquire a desirable file using the image reading apparatus or the software. Thus, the information processing apparatus 200 can enhance the convenience of the user.

The notification unit 224 identifies information relating to an image reading apparatus or software with the capability information satisfying the second criterion for the characteristic information, among the other image reading apparatuses or the other software, and notifies the user of the information, in a manner similar to the process in step S111 (step S117). Accordingly, the user can recognize the image reading apparatus or the software that can more efficiently generate a file corresponding to the designated storage destination, and can acquire a desirable file using the image reading apparatus or the software. Thus, the information processing apparatus 200 can enhance the convenience of the user.

After the process in step S107, S111, or S117, the notification unit 224 determines a recommended value of a setting relating to the conveyance processing, the image-capturing processing, or the image processing, notifies the user of the recommended value in a manner similar to the process in step S105 (step S118), and ends the series of steps.

The notification unit 224 determines the recommended value based on the mainstream characteristic information generated based on the characteristic information. For the item of the medium separation, the notification unit 224 sets the recommended value to ON when the characteristic value of the number of continuous scans is 2 or more, and sets the recommended value to OFF when the characteristic value of the medium type is passport. For the item of the multi-feed detection, the notification unit 224 sets the recommended value to ON when the characteristic value of the number of continuous scans is 2 or more, and sets the recommended value to OFF when the characteristic value of the medium type is envelope or sheet with sticky note attached. For the other items, the notification unit 224 identifies the characteristic value of each item of the mainstream characteristic information as the recommended value. Accordingly, the user can recognize appropriate setting information corresponding to the existing file present in the designated storage destination and can appropriately correct the setting information. Thus, the information processing apparatus 200 can enhance the convenience of the user.

The notification unit 224 may determine the recommended value based on the mainstream characteristic information generated based on the characteristic information within the range of the capability indicated in the capability information of the image reading apparatus 100 to be used. For example, the notification unit 224 extracts recommended values not supported by the corresponding capability values in the capability information among the recommended values determined as described above. For each of the extracted recommended values, the notification unit 224 determines, as the recommended value, a capability value for which the highest capability is required among the corresponding capability values in the capability information. For example, when the item is the resolution, a higher capability is required as the resolution is higher. When the item is the medium size, a higher capability is required as the size is larger. When the item is the color, a higher capability is required in the order of color, grayscale, and binary. The notification unit 224 sets the recommended value of the medium separation to OFF when the recommended value of the medium separation is ON and the capability value of the separation function is absent, and sets the recommended value of the medium separation to ON when the recommended value of the medium separation is OFF and the capability value of the non-separation function is absent. The notification unit 224 sets the recommended value of the multi-feed detection to OFF when the recommended value of the multi-feed detection is ON and the capability value of the multi-feed detection is absent, and sets the recommended value of the multi-feed detection to ON when the recommended value of the multi-feed detection is OFF and the capability value of the multi-feed detection disable function is absent. Accordingly, the user can correct the setting information within the range executable by the image reading apparatus 100 to be used. Thus, the information processing apparatus 200 can enhance the convenience of the user.

The process in step S105, the processes in steps S106 and S107, the process in step S109, the processes in steps S110 and S111, the process in step S114, the processes in steps S115 to S117, or the process in step S118 may be omitted. The processes in steps S106 and S107 may be executed even when it is determined that the capability information of the image reading apparatus 100 corresponds to the characteristic information. The processes in steps S110 and S111 may be executed even when it is determined that the capability information of the image reading apparatus 100 satisfies the second criterion for the characteristic information.

As described above in detail, the information processing apparatus 200 notifies the user when the capability information of the image reading apparatus 100 does not match the characteristic information of the existing file present in the designated storage destination. Accordingly, the information processing apparatus 200 can enhance the convenience of the user when selecting the image reading apparatus 100.

In particular, even when the user has low knowledge or skill relating to the image reading process, the user is notified of the information relating to the image reading apparatus 100 not having the capability of generating a desirable image, and thus the user can appropriately select a usable image reading apparatus 100. Accordingly, the information processing apparatus 200 can prevent a redo of the image reading process due to selection of an inappropriate image reading apparatus 100, and can prevent a decrease in work efficiency or work quality of the user.

When the image processing system 1 is used for operations, a plurality of users may use a plurality of image reading apparatuses 100 to perform distributed work, and files may be stored in a specific storage destination. Each user can appropriately select an image reading apparatus 100 having a capability of generating a file even for a file generated in work by another user. Accordingly, in operations in which a plurality of users performs distributed work, the information processing apparatus 200 can increase the work efficiency of the users.

When the image reading apparatus 100 is used for operations, a role or a purpose is likely to be explicitly or implicitly assigned to a folder of a storage destination in which an image file that is generated by the image reading apparatus 100 is stored. For example, a business card and an order form are likely to be stored in the same storage destination so that the business card and the order form are collectively managed. By determining whether each image reading apparatus 100 has a capability of generating an image file stored in a folder of a designated storage destination, the information processing apparatus 200 can accurately determine whether each image reading apparatus 100 corresponds to the desirable role or purpose.

When a user performs operations of collectively processing a large number of media, the user can select an ADF image reading apparatus that can collectively read a large number of media at high speed. When media to be processed possibly include a medium with damage, the user can select a flatbed image reading apparatus or an image reading apparatus that supports conveyance of carrier sheets. When media to be processed possibly include a form with a sticky note having a memo, the user can select an image reading apparatus having the multi-feed detection disable function. Thus, the information processing apparatus 200 can enhance the convenience of the user.

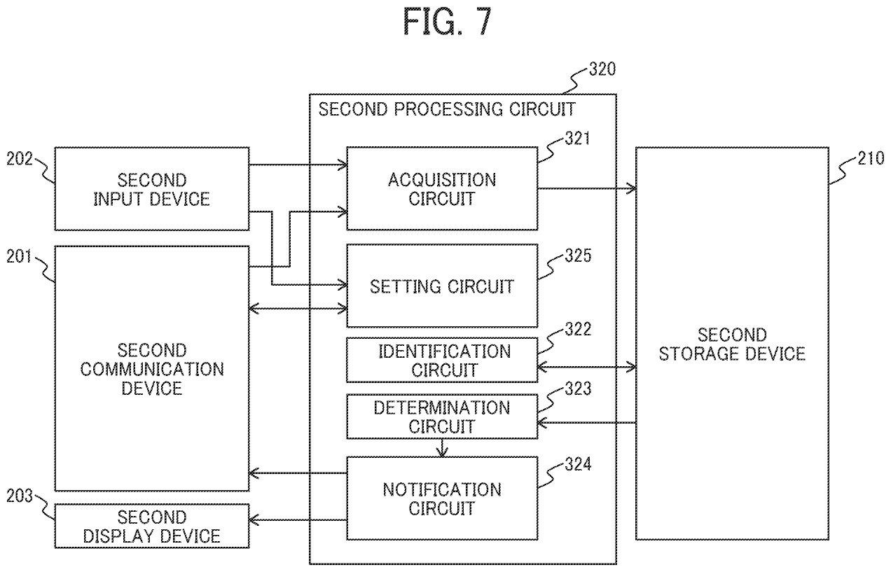

FIG. 7 is a block diagram schematically illustrating a configuration of a second processing circuit 320 in an information processing apparatus according to another embodiment.

The second processing circuit 320 is used instead of the second processing circuit 220 and executes, for example, a determination process. The second processing circuit 320 includes an acquisition circuit 321, an identification circuit 322, a determination circuit 323, a notification circuit 324, and a setting circuit 325.

The acquisition circuit 321 is an example of an acquisition unit and functions like the acquisition unit 221. The acquisition circuit 321 receives capability information and a storage destination from the second communication device 201 or the second input device 202, and stores the capability information and the storage destination in the second storage device 210.

The identification circuit 322 is an example of an identification unit and functions like the identification unit 222. The identification circuit 322 reads the storage destination from the second storage device 210, identifies characteristic information of an existing file present in the storage destination, sets index information, and stores the index information in the second storage device 210.

The determination circuit 323 is an example of a determination unit and functions like the determination unit 223. The determination circuit 323 reads the capability information and the index information from the second storage device 210, determines whether the capability information corresponds to the characteristic information, and outputs a determination result to the notification circuit 324.

The notification circuit 324 is an example of a notification unit and functions like the notification unit 224. The notification circuit 324 receives the determination result of whether the capability information corresponds to the characteristic information from the determination circuit 323, and outputs information relating to the determination result to the second communication device 201 or the second display device 203.

The setting circuit 325 is an example of a setting unit and functions like the setting unit 225. The setting circuit 325 receives setting information from the second communication device 201 or the second input device 202, and transmits the setting information to the corresponding image reading apparatus 100 via the second communication device 201.

As described above in detail, the information processing apparatus can enhance the convenience of the user even when the second processing circuit 320 is used.

Although the preferred embodiments have been described above, the embodiments are not limited thereto. For example, the determination process may be executed by the image reading apparatus 100 instead of the information processing apparatus 200. In this case, the first storage device 110 of the image reading apparatus 100 stores each information and each program stored in the second storage device 210 of the information processing apparatus 200. The first processing circuit 120 functions as an acquisition unit, an identification unit, a determination unit, a notification unit, and a setting unit similar to the acquisition unit 221, the identification unit 222, the determination unit 223, the notification unit 224, and the setting unit 225.

In this case, in step S101 in FIG. 3, the acquisition unit reads capability information of the image reading apparatus 100 from the first storage device 110 to acquire the capability information of the image reading apparatus 100. The acquisition unit acquires a storage destination input by the user using the first input device 102. Alternatively, the acquisition unit receives a storage destination input by the user using the second input device 202 of the information processing apparatus 200 from the information processing apparatus 200 via the first communication device 101 to acquire the storage destination. In steps S105, S107, S109, S111, S114, S116, S117, and S118, the notification unit notifies the user of each information by displaying each information on the first display device 103 or by transmitting each information to the information processing apparatus 200 via the first communication device 101 and causing the information processing apparatus 200 to display the information. In step S112, the acquisition unit acquires setting information of the image reading apparatus 100 by reading the setting information from the first storage device 110. The setting controller 121 functions as a setting unit.

Accordingly, the image reading apparatus 100 can enhance the convenience of the user.

It is desired to enhance convenience of a user when the user selects an image reading apparatus in a system using the image reading apparatus.

According to one embodiment of the present disclosure, an image processing apparatus, a control method, and a non-transitory computer-executable medium that can enhance the convenience of a user are provided.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

1. An image processing apparatus, comprising circuitry configured to:
acquire capability information relating to conveyance processing, image-capturing processing, or image processing of an image reading apparatus, and a storage destination of a file that is generated by the image reading apparatus;
identify characteristic information of an existing file present in the storage destination;
determine whether the capability information of the image reading apparatus corresponds to the characteristic information and generate a determination result; and
notify a user of information relating to the determination result in a case where the determination result indicates that the capability information does not correspond to the characteristic information.

2. The image processing apparatus according to claim 1, wherein the information relating to the determination result indicates that the image reading apparatus is not appropriate.

3. The image processing apparatus according to claim 1, wherein the image reading apparatus includes software installed therein, and the circuitry is configured to:
further acquire capability information of other image reading apparatuses or other software different from the software; and
notify the user of information relating to an image reading apparatus or software having a capability corresponding to the characteristic information.

4. The image processing apparatus according to claim 1, wherein
the circuitry is configured to:
in the case where the determination result indicates that the capability information of the image reading apparatus does not correspond to the characteristic information,
acquire the capability information of the other image reading apparatuses or the other software; and
notify the user of the information relating to the image reading apparatus or the software having the capability corresponding to the characteristic information among the other image reading apparatuses or the other software.

5. The image processing apparatus according to claim 1, wherein the circuitry is configured to:
determine whether the capability information satisfies a predetermined criterion for the characteristic information and generate another determination result; and
notify the user that the image reading apparatus is inefficient in a case where the determination result indicates that the capability information corresponds to the characteristic information and said another determination result indicates that the capability information does not satisfy the predetermined criterion for the characteristic information.

6. The image processing apparatus according to claim 5, wherein
the image reading apparatus includes software installed therein, and
the circuitry is configured to:
in a case where said another determination result indicates that the capability information does not satisfy the predetermined criterion for the characteristic information,
acquire the capability information of other image reading apparatuses or other software different from the software; and
notify the user of information relating to an image reading apparatus or software having the capability information satisfying the predetermined criterion for the characteristic information among the other image reading apparatuses or the other software.

7. The image processing apparatus according to claim 1, wherein the circuitry is configured to further notify the user of a recommended value of a setting relating to the conveyance processing, the image-capturing processing, or the image processing within a range of a capability indicated in the capability information based on the characteristic information.

8. The image processing apparatus according to claim 1, wherein
the image reading apparatus includes software installed therein, and
the circuitry is configured to:
set setting information of a second image reading apparatus, wherein the second image reading apparatus is different from the image reading apparatus, and the setting information of the second image reading apparatus is set in advance and relating to the conveyance processing, the image-capturing processing, or the image processing, and
in a case where the setting information in the second image reading apparatus does not correspond to the characteristic information, further acquire the capability information of other image reading apparatuses or other software different from the software and notify the user of information relating to an image reading apparatus or software having a capability corresponding to the characteristic information among the other image reading apparatuses or the other software.

9. A control method, comprising:
acquiring capability information relating to conveyance processing, image-capturing processing, or image processing of an image reading apparatus, and a storage destination of a file that is generated by the image reading apparatus;
identifying characteristic information of an existing file present in the storage destination;
determining whether the capability information of the image reading apparatus corresponds to the characteristic information and generating a determination result; and
notifying a user of information relating to the determination result in a case where the determination result indicates that the capability information does not correspond to the characteristic information.

10. A non-transitory computer-executable medium storing a control program storing a plurality of instructions, which, when executed by one or more processors, causes the one or more processors to perform a method comprising:
acquiring capability information relating to conveyance processing, image-capturing processing, or image processing of an image reading apparatus, and a storage destination of a file that is generated by the image reading apparatus;
identifying characteristic information of an existing file present in the storage destination;
determining whether the capability information of the image reading apparatus corresponds to the characteristic information and generating a determination result; and
notifying a user of information relating to the determination result in a case where the determination result indicates that the capability information does not correspond to the characteristic information.
